(19) United States
(12) Patent Application Publication
(10) Pub. No.: US 2025/0245609 A1
(43) Pub. Date: Jul. 31, 2025

(54) INFORMATION PROCESSING APPARATUS, SYSTEM, AND OPERATING METHOD FOR SYSTEM

(71) Applicant: TOYOTA JIDOSHA KABUSHIKI KAISHA, Toyota-shi Aichi-ken (JP)

(72) Inventors: Tomiyasu ISHIKAWA, Okazaki-shi Aichi-ken (JP); Tadashi MATSUI, Kasugai-shi Aichi-ken (JP); Takumi KOZAWA, Nagoya-shi Aichi-ken (JP); Yuto MOTOYAMA, Nagoya-shi Aichi-ken (JP); Tsuyoshi OKADA, Nagoya-shi Aichi-ken (JP); Yoshiaki MASUYA, Inazawa-shi Aichi-ken (JP)

(73) Assignee: TOYOTA JIDOSHA KABUSHIKI KAISHA, Toyota-shi Aichi-ken (JP)

(21) Appl. No.: 19/037,904

(22) Filed: Jan. 27, 2025

(30) Foreign Application Priority Data
Jan. 29, 2024 (JP) 2024-011326

(51) Int. Cl. G06Q 10/0833; G06F 3/0481; G06T 11/00; H04N 7/18; H04N 23/661

(52) U.S. Cl. CPC G06Q 10/0833; G06F 3/0481; G06T 11/00; H04N 7/183; H04N 23/661

(57) ABSTRACT

An information processing apparatus includes a communication interface, a memory configured to store information indicating a delivery status of a certain vehicle, and a controller configured to communicate by the communication interface. The controller is configured to transmit, to a terminal apparatus, information to confirm a current status of the certain vehicle on the condition that the delivery status reaches a predetermined status.

### CROSS-REFERENCE TO RELATED APPLICATION

This application claims priority to Japanese Patent Application No. 2024-011326, filed on Jan. 29, 2024, the entire contents of which are incorporated herein by reference.

### TECHNICAL FIELD

The present disclosure relates to an information processing apparatus, a system, and an operating method for a system.

### BACKGROUND

Technology for presenting shipment statuses and other information to users until products purchased by the users are in the users' possession is known. For example, in the purchase of vehicles, which requires certain amounts of time before delivery, technology for presenting, to users, progress statuses until the delivery is proposed. For example, Patent Literature (PTL) 1 discloses a system that provides user terminals with information regarding progress statuses of vehicles before delivery, which is stored in a progress management database.

### CITATION LIST

### Patent Literature

PTL 1: JP 2002-297954 A

### SUMMARY

For users waiting for delivery of vehicles, when additional waiting time is required, even though the vehicles purchased by the users have already arrived at car dealers' stores, the users' stress may increase. Thus, there is room to alleviate such stress and improve the users' convenience.

Here discloses an information processing apparatus and the like that can improve the convenience of users who are waiting for delivery of vehicles.

An information processing apparatus according to the present disclosure includes:
a communication interface;
a memory configured to store information indicating a delivery status of a certain vehicle; and
a controller configured to communicate by the communication interface,
wherein the controller is configured to transmit, to a terminal apparatus, information to confirm a current status of the certain vehicle on the condition that the delivery status reaches a predetermined status.

A system according to the present disclosure is a system including:
an information processing apparatus configured to store information indicating a delivery status of a certain vehicle; and
a terminal apparatus configured to communicate with the information processing apparatus,
wherein
the information processing apparatus is configured to transmit, to the terminal apparatus, information to confirm a current status of the certain vehicle on the condition that the delivery status reaches a predetermined status, and
the terminal apparatus is configured to output the information to confirm the current status.

An operating method for a system according to the present disclosure is an operating method for a system including an information processing apparatus configured to store information indicating a delivery status of a certain vehicle, and a terminal apparatus configured to communicate with the information processing apparatus, the operating method including:
transmitting, by the information processing apparatus to the terminal apparatus, information to confirm a current status of the certain vehicle on the condition that the delivery status reaches a predetermined status; and
outputting, by the terminal apparatus, the information to confirm the current status.

According to the information processing apparatus and the like of the present disclosure, it is possible to improve the convenience of users who are waiting for delivery of vehicles.

### BRIEF DESCRIPTION OF THE DRAWINGS

In the accompanying drawings:

FIG. 1 is a diagram illustrating an example of a configuration of an information processing system;

FIG. 2 is a diagram illustrating an example of a configuration of a server apparatus;

FIG. 3 is a diagram illustrating an example of a configuration of a terminal apparatus;

FIG. 4 is a diagram illustrating an example of a configuration of an in-vehicle apparatus;

FIG. 5 is a sequence diagram illustrating an example of operations of the information processing system;

FIG. 6 is a sequence diagram illustrating an example of further operations of the information processing system;

FIG. 7 is a diagram illustrating an example of display of an exterior image;

FIG. 8 is a sequence diagram illustrating an example of yet other operations of the information processing system; and

FIG. 9 is a diagram illustrating an example of display of a confirmation image.

### DETAILED DESCRIPTION

An embodiment will be described below.

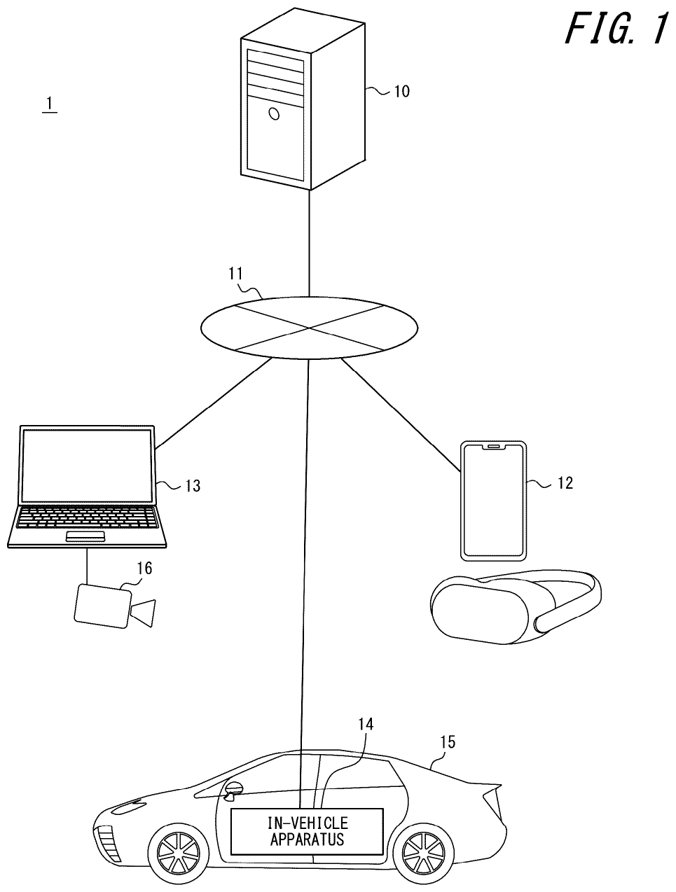

FIG. 1 is a diagram illustrating an example of a configuration of an information processing system according to the embodiment. An information processing system 1 includes at least one server apparatus 10, at least one terminal apparatus 12, at least one terminal apparatus 13, and at least one in-vehicle apparatus 14 that are communicably connected to each other via a network 11. The server apparatus 10 is, for example, a server computer that belongs to a cloud computing system or another computing system and functions as a server that implements various functions. The server apparatus 10 corresponds to “information processing apparatus” in the present embodiment. The terminal apparatuses 12 and 13 are information processing apparatuses with communication functions. The terminal apparatus 12 is used by a purchaser (hereinafter referred to as “user”) of a vehicle 15, and the terminal apparatus 13 is used by a person in charge at a car dealer to which the vehicle 15 is delivered before delivery to the user. The terminal apparatuses 12 and 13 are, for example, smartphones, tablet terminals, or the like. The terminal apparatus 12 may include a user-wearable virtual reality (VR) terminal. To the terminal apparatus 13, an external camera 16 may be connected. The in-vehicle apparatus 14 is a control apparatus for equipment installed in the vehicle 15. The in-vehicle apparatus 14 may include the equipment itself. The equipment is, for example, a navigation system, an air conditioner, a lighting system including headlights and blinkers, a sound system including a horn, and the like. The network 11 is the Internet, for example, but may also be an ad-hoc network, a LAN, a Metropolitan Area Network (MAN), other networks, or a combination of two or more thereof.

In the present embodiment, the information processing system 1 transmits, to the user, information to confirm a current status of the vehicle 15 purchased by the user, until the vehicle 15, which has been purchased by the user and has been delivered to the car dealer's store, is delivered to the user's home or other location. Specifically, the server apparatus 10 stores information indicating a delivery status of the vehicle 15, and transmits, to the terminal apparatus 12, the information to confirm the current status of the vehicle 15 on the condition that the delivery status reaches a predetermined status. The user can confirm the current status of the vehicle 15 by operating the terminal apparatus 12, which reduces the user's stress related to waiting for delivery of the vehicle 15. Therefore, it is possible to improve the convenience of users who are waiting for delivery of vehicles.

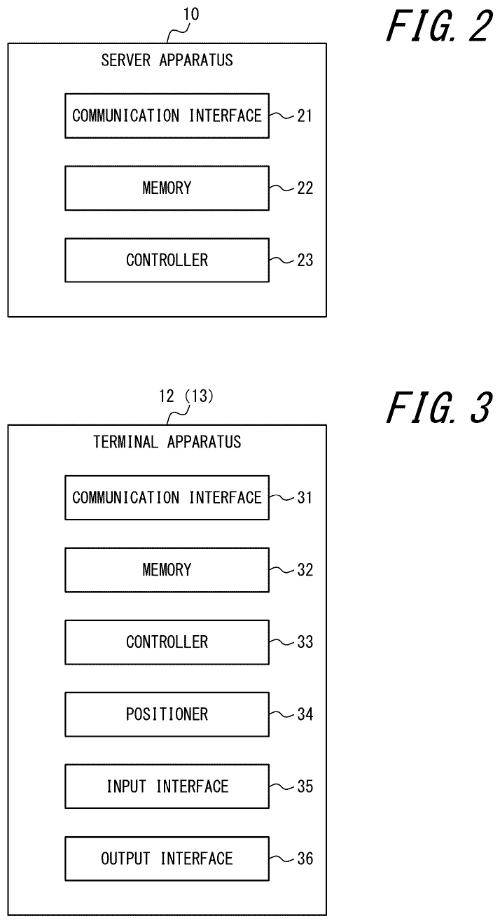

FIG. 2 is a diagram illustrating an example of a configuration of the server apparatus 10. The server apparatus 10 includes a communication interface 21, a memory 22, and a controller 23. The server apparatus 10 may be a single server computer or may be two or more computers that are communicably connected to each other and operate in cooperation. In this case, the configuration illustrated in FIG. 2 can be arranged as appropriate among two or more server computers.

The communication interface 21 includes one or more interfaces for communication. The interfaces for communication include, for example, a LAN interface. The communication interface 21 receives information to be used for operations of the server apparatus 10, and transmits information obtained by the operations of the server apparatus 10. The server apparatus 10 is connected to the network 11 by the communication interface 21, and communicates information with other apparatuses via the network 11.

The memory 22 includes, for example, one or more semiconductor memories, one or more magnetic memories, one or more optical memories, or a combination of at least two of these types, to function as main memory, auxiliary memory, or cache memory. The semiconductor memories are, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information to be used for the operations of the server apparatus 10 and information obtained by the operations of the server apparatus 10.

The controller 23 includes one or more processors, one or more dedicated circuits, or a combination thereof. The processors are general purpose processors, such as central processing units (CPUs), or dedicated processors, such as graphics processing units (GPUs), specialized for particular processes. The dedicated circuits are, for example, field-programmable gate arrays (FPGAs), application specific integrated circuits (ASICs), or the like. The controller 23 executes information processing related to the operations of the server apparatus 10 while controlling components of the server apparatus 10.

The functions of the server apparatus 10 are realized by a processor included in the controller 23 executing a control program. The control program is a program for causing a server computer to execute processing of steps included in the operations of the server apparatus 10, thereby enabling the server computer to realize the functions corresponding to the processing of the steps. That is, the control program is a program for causing a computer to function as the server apparatus 10. Some or all of the functions of the server apparatus 10 may be realized by the dedicated circuits included in the controller 23. The control program may be stored on a non-transitory recording/storage medium readable by the server apparatus 10, and be read from the medium by the server apparatus 10.

FIG. 3 is a diagram illustrating a configuration of the terminal apparatus 12. The example configuration of the terminal apparatus 12 illustrated herein is also applied to the terminal apparatus 13. The terminal apparatus 12 includes a communication interface 31, a memory 32, a controller 33, an input interface 35, and an output interface 36. The terminal apparatus 12 may include a positioner 34.

The communication interface 31 includes one or more interfaces for communication compatible with wired or wireless LAN standards. The interfaces for communication include an interface corresponding to a mobile communication standard, such as Long Term Evolution (LTE), the 4th Generation (4G) standard, or the 5th Generation (5G) standard. The interfaces for communication include an interface compliant with a short-range wireless communication standard, such as Wi-Fi® (Wi-Fi is a registered trademark in Japan, other countries, or both), Bluetooth® (Bluetooth is a registered trademark in Japan, other countries, or both), or infrared communication. The terminal apparatus 13 connects to the network 11 via a nearby router apparatus or mobile communication base station using the communication interface 31, and communicates information with other apparatuses over the network 11.

The memory 32 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for operations of the controller 33 and information obtained by the operations of the controller 33.

The controller 33 has one or more general purpose processors such as CPUs or micro processing units (MPUs), or one or more dedicated processors that are dedicated to specific processing. Alternatively, the controller 33 may have one or more dedicated circuits such as FPGAs or ASICs. The controller 33 performs overall control of operations of the terminal apparatus 13 by operating according to control/processing programs or operating according to operating procedures implemented in the form of circuits. The controller 33 then transmits and receives various types of information to and from the server apparatus 10 and the like via the communication interface 31, and executes operations according to the present embodiment.

The positioner 34 includes one or more Global Navigation Satellite System (GNSS) receivers. The GNSS includes, for example, Global Positioning System (GPS), Quasi-Zenith Satellite System (QZSS), BeiDou, Global Navigation Satellite System (GLONASS), and/or Galileo. The positioner 34 acquires positional information on the terminal apparatus 13, and transmits the positional information to the controller 33.

The input interface 35 includes one or more interfaces for input. The interfaces for input are, for example, physical keys, capacitive keys, a pointing device, a touch screen integrally provided with a display, or a microphone that receives audio input. The interfaces for input may further include a camera that captures images or image codes, or an IC card reader. When the terminal apparatus 12 includes a VR terminal such as a head-mounted display, the input interface 35 may include a tracking sensor to detect the user's gesture movements. The terminal apparatus 13 may also include an interface to an external camera 16. The input interface 35 accepts operations for inputting information to be used in the operations of the controller 33, and transmits the input information to the controller 33.

The output interface 36 includes one or more interfaces for output. The interfaces for output include, for example, a display or a speaker. The display is, for example, a liquid crystal display (LCD) or an organic electro-luminescence (EL) display. When the terminal apparatus 12 includes a VR terminal such as a head-mounted display, the display may be a heads-up display or the like. The output interface 36 outputs information obtained by the operations of the controller 33.

The functions of the controller 33 are realized by a processor included in the controller 33 executing a control program. The control program is a program for causing the processor to function as the controller 33. Some or all of the functions of the controller 33 may be realized by a dedicated circuit included in the controller 33.

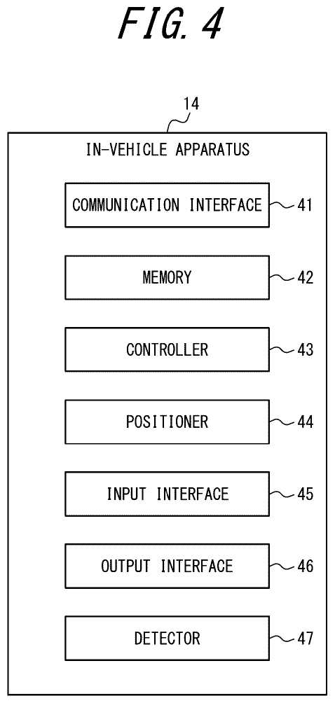

FIG. 4 illustrates an example of a configuration of the in-vehicle apparatus 14. The in-vehicle apparatus 14 includes a communication interface 41, a memory 42, a controller 43, a positioner 44, an input interface 45, an output interface 46, and a detector 47. These components may be configured as a single control apparatus, as two or more control apparatuses, or with another apparatus such as a control apparatus and a communication device. The control apparatus includes an electronic control unit (ECU), for example. The communication device includes a data communication module (DCM), for example. The components are communicably connected to each other or to equipment in the vehicle 15, by an in-vehicle network compliant with a standard such as a controller area network (CAN). The equipment in the vehicle 15 is, for example, a navigation system, an air conditioner, a lighting system including headlights and blinkers, a sound system including a horn, and the like.

The communication interface 41 includes one or more interfaces for communication. The interfaces for communication include, for example, an interface corresponding to a mobile communication standard, such as LTE, the 4G standard, or the 5G standard. The interfaces for communication include an interface compliant with a short-range wireless communication standard, such as Wi-Fi®, Bluetooth®, or infrared communication. The communication interface 41 receives information to be used for operations of the controller 43, and transmits information obtained by the operations of the controller 43. The controller 43 connects to the network 11 using the communication interface 41 through a mobile communication base station, and communicates information with other apparatuses via the network 11.

The memory 42 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 42 functions as, for example, a main memory, an auxiliary memory, or a cache memory. The memory 42 stores information to be used for the operations of the controller 43 and information obtained by operations of the in-vehicle apparatus 14.

The controller 43 includes one or more processors, one or more dedicated circuits, or a combination thereof. The processors are general purpose processors such as CPUs or dedicated processors dedicated to specific processing. The dedicated circuits are, for example, FPGAs or ASICs. The controller 43 executes information processing related to operations of the vehicle 15 while controlling the components of the controller 43.

The positioner 44 includes one or more GNSS receivers. GNSS includes, for example, GPS, QZSS, BeiDou, GLONASS, and/or Galileo. The positioner 44 acquires positional information on the vehicle 15, and transmits the positional information to the controller 43.

The input interface 45 includes one or more interfaces for input. The interfaces for input are, for example, physical keys, capacitive keys, a pointing device, a touch screen integrally provided with a display, or a microphone that receives audio input. The interfaces for input may further include a camera that captures images or image codes, or an IC card reader. The input interface 45 accepts operations by the user for inputting information to be used in the operations of the controller 43, and transmits the input information to the controller 43.

The output interface 46 includes one or more interfaces for output. The interfaces for output include, for example, a display or a speaker. The display is, for example, an LCD or an organic EL display. The output interface 46 outputs, to the user, information obtained by the operations of the controller 43, for example.

The detector 47 has interfaces with one or more sensors that detect states of various parts of the vehicle 15, or has the one or more sensors. The sensors include, for example, sensors that detect the temperature of the various parts of the vehicle 15, battery charge remaining, and kinetic states (speed, forward/backward acceleration, left/right acceleration, deceleration, and the like) of the vehicle 15. The detector 47 transmits, to the controller 43, information indicating the individual states detected by the sensors.

The functions of the controller 43 are realized by a processor included in the controller 43 executing a control program. The control program is a program for causing a computer to execute processing of steps included in the operations of the controller 43, thereby enabling the computer to realize the functions corresponding to the processing of the steps. That is, the control program is a program for causing a computer to function as the controller 43. Some or all of the functions of the controller 43 may be realized by a dedicated circuit included in the controller 43.

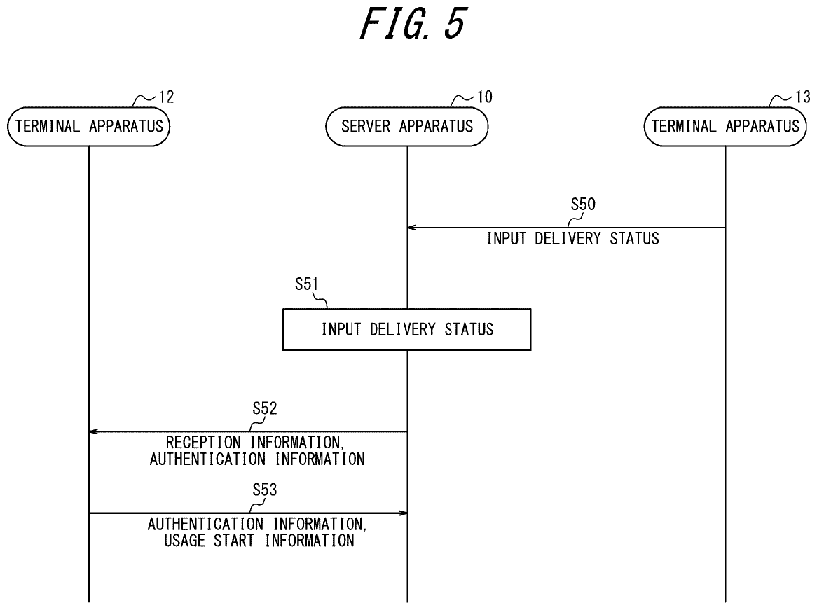

FIG. 5 is a sequence diagram illustrating an operating procedure of the information processing system 1 according to the present embodiment. FIG. 5 illustrates the procedure for interconnected operations of the server apparatus 10 and the terminal apparatuses 12 and 13 when the user confirms a current status of the purchased vehicle 15 while waiting for delivery. The steps pertaining to various types of information processing by the server apparatus 10 and the terminal apparatuses 12 and 13 in FIG. 5 are performed by the controllers 23, 33, and 33, respectively. The steps pertaining to transmission and reception of various types of information to and from the server apparatus 10 and the terminal apparatuses 12 and 13 are performed by the controllers 21, 31, and 31 transmitting and receiving information to and from each other via the communication interfaces 23, 33, and 33, respectively. In the server apparatus 10 and the terminal apparatuses 12 and 13, the controllers 23, 33, and 33 appropriately store the transmitted and received information in the memories 22, 32, and 32, respectively. Furthermore, the controllers 23, 33, and 33 accept input of various types of information by the input interfaces 35, 35, and 35, and output various types of information by the output interfaces 36, 36, and 36, respectively.

In step S50, the terminal apparatus 13 transmits, to the server apparatus 10, input information on a delivery status. The person in charge at the car dealer inputs, by operating the terminal apparatus 13, information indicating a delivery status of the vehicle 15 and transmits the information to the server apparatus 10.

In step S51, the server apparatus 10 updates the delivery status. The memory 22 of the server apparatus 10 stores the information on the delivery status. The information on the delivery status includes, for each vehicle purchased, information on a stage indicating the delivery status. The delivery status has stages of, for example, “in production”, “in inspection”, “in transport”, “equipped with options”, “arrival at store”, and the like. The server apparatus 10 updates a stage of the delivery status to a stage of the delivery status transmitted from the terminal apparatus 13.

In step S52, the server apparatus 10 transmits the information on the delivery status to the terminal apparatus 12.

In step S53, the terminal apparatus 12 transmits a confirmation request to the server apparatus 10. The terminal apparatus 12 displays the stage of the delivery status to the user. According to the stage, the user transmits a confirmation request to the server apparatus 10 by operating the terminal apparatus 12. For example, the terminal apparatus 12 transmits the confirmation request to the server apparatus 10 on the condition that the stage of the delivery status is “arrival at store”. The confirmation request is information to request confirmation of the current status of the vehicle 15 that has arrived at the car dealer's store.

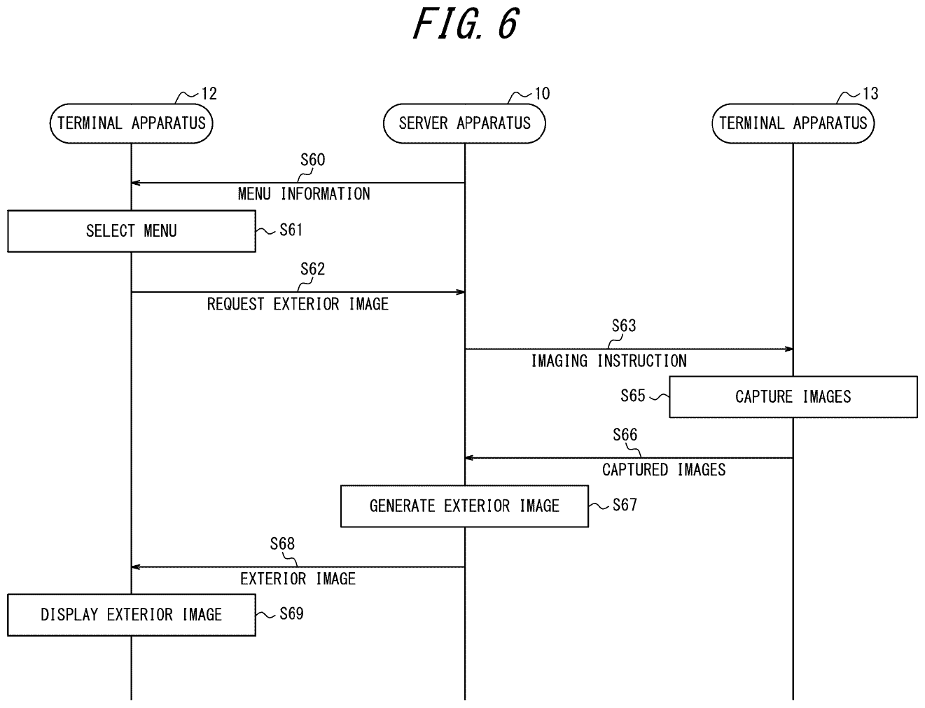

FIG. 6 is a sequence diagram illustrating a further operating procedure of the information processing system 1. FIG. 6 illustrates the procedure for interconnected operations of the server apparatus 10 and the terminal apparatuses 12 and 13 that are performed after the user has transmitted the confirmation request to the server apparatus 10 in the procedure in FIG. 5. As in FIG. 5, each step in FIG. 6 is executed by the controller or the like of each apparatus.

Next, in step S60, the server apparatus 10 transmits menu information to the terminal apparatus 12 in response to the confirmation request. The menu information includes options for how to confirm the current status of the vehicle 15, e.g., an option to display an exterior image of the vehicle 15.

In step S61, the terminal apparatus 12 accepts a selection for a menu. For example, the terminal apparatus 12 displays a menu screen based on the menu information, and accepts a selection operation by the user. Here is an example in which the user requests the exterior image of the vehicle 15.

In step S62, the terminal apparatus 12 transmits, to the server apparatus 10, a request for the exterior image.

In step S63, the server apparatus 10 transmits an imaging instruction to the terminal apparatus 13. In response to the request for the exterior image, the server apparatus 10 transmits, to the terminal apparatus 13, an instruction to cause the terminal apparatus 13 to image the exterior of the vehicle 15.

In step S65, the terminal apparatus 13 images the vehicle 15 in response to the imaging instruction. The terminal apparatus 13 controls, for example, the external camera 16 to image the vehicle 15, to acquire captured images. The camera 16 is installed, at the store, at any location from which the exterior of the vehicle 15 can be imaged. The images are captured at any frame rate.

In step S66, the terminal apparatus 13 transmits the captured images to the server apparatus 10. The captured images may be still images or a moving image of any duration.

In step S67, the server apparatus 10 generates the exterior image. The server apparatus 10 performs arbitrary image processing, such as brightness adjustment, color conversion, and various types of correction, on the captured images to generate the exterior image to display the exterior of the vehicle 15.

In step S68, the server apparatus 10 transmits the exterior image to the terminal apparatus 12.

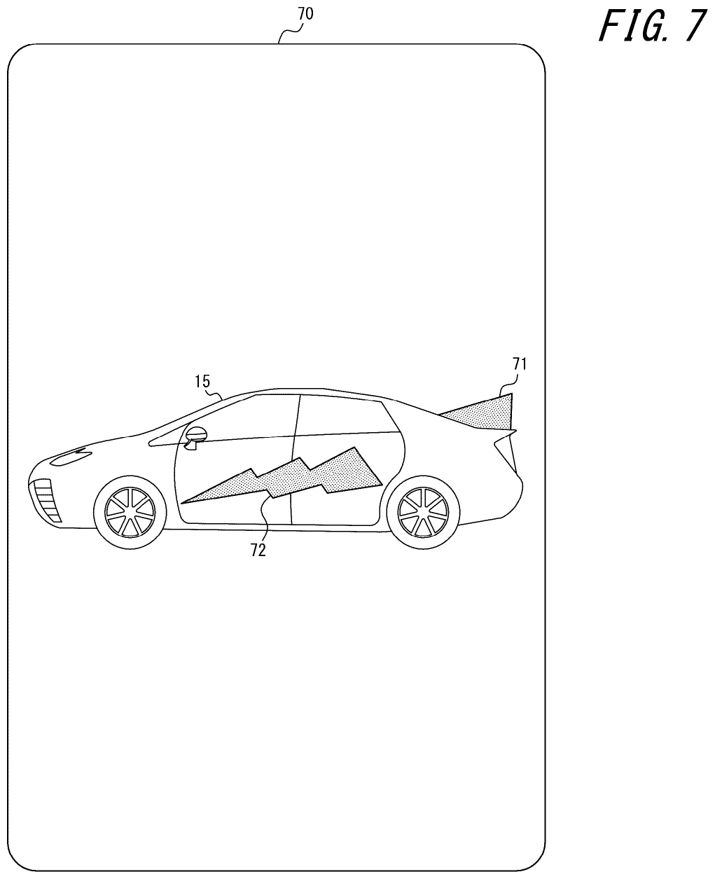

In step S69, the terminal apparatus 12 displays the exterior image. The terminal apparatus 12 presents the exterior image of the vehicle 15 to the user. For example, as illustrated in an example of display of the exterior image in FIG. 7, the terminal apparatus 12 displays an exterior image 70 of the vehicle 15 that includes an optional part 71, an optional design 72, and the like added to the vehicle 15. For example, the terminal apparatus 12 may display the exterior image 70 on a display of a smartphone, a tablet terminal, or the like, or may display the exterior image 70 on a head-mounted display of a VR device.

The user can thereby appreciate the current state, that is, the exterior of the vehicle 15, as a specific object that the user has purchased and added options to as appropriate, while waiting for delivery of the vehicle 15. Therefore, it is possible to improve the convenience of users who are waiting for delivery of vehicles.

Although the example of displaying the exterior image of the vehicle 15 to the user is described above, the present embodiment includes the case of displaying an interior image of the vehicle 15 to the user. In such a case, for example, the camera 16 at the store is installed at any location from which the interior of the vehicle 15 can be imaged. The exterior image or an image for displaying the interior of the vehicle 15 may be generated by the terminal apparatus 12 by the server apparatus 10 transmitting corresponding captured images to the terminal apparatus 12.

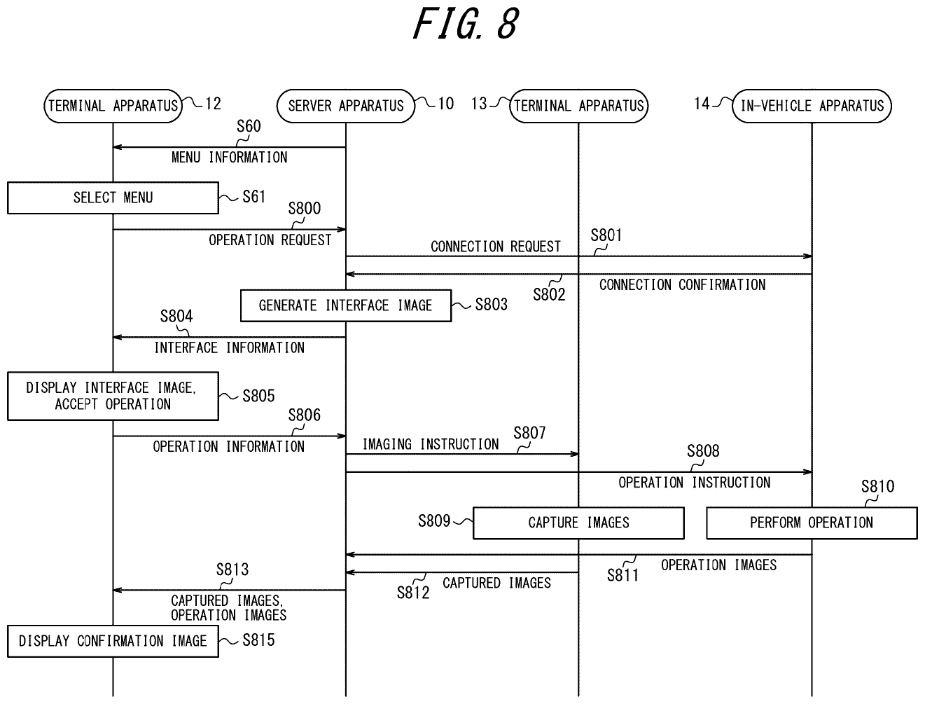

FIG. 8 is a sequence diagram illustrating a yet other operating procedure of the information processing system 1. FIG. 8 illustrates the procedure for interconnected operations of the server apparatus 10, the terminal apparatuses 12 and 13, and the in-vehicle apparatus 14 that are performed after the user has transmitted the confirmation request to the server apparatus 10 in the procedure in FIG. 5. As in FIG. 5, each step in FIG. 8 is executed by the controller or the like of each apparatus, or by the controller 43, the communication interface 41, or the like in the in-vehicle apparatus 14.

When the server apparatus 10 transmits menu information to the terminal apparatus 12 in response to the confirmation request in step S60, the terminal apparatus 12 accepts a selection for a menu in step S61. Here is an example in which the user requests an operation on equipment of the vehicle 15.

In step S800, the terminal apparatus 12 transmits, to the server apparatus 10, an operation request on the equipment.

In step S801, in response to the operation request, the server apparatus 10 transmits, to the in-vehicle apparatus 14, a communication connection request for the operation on the equipment. At this time, the in-vehicle apparatus 14 is turned on and activated by the person in charge at the car dealer, for example. For example, a notification to prompt for activation of the in-vehicle apparatus 14 may be transmitted from the server apparatus 10 to the terminal apparatus 13, and the terminal apparatus 13 may output information to prompt the person in charge to activate the in-vehicle apparatus 14.

In step S802, in response to the connection request, the in-vehicle apparatus 14 transmits, to the server apparatus 10, a connection confirmation to establish a connection.

In step S803, the server apparatus 10 generates an interface image. The interface image is an image that provides an interface for the user to operate the equipment. The server apparatus 10 generates the interface image based on any algorithm and screen design.

In step S804, the server apparatus 10 transmits interface information to the terminal apparatus 12. The interface information includes information for displaying the interface image.

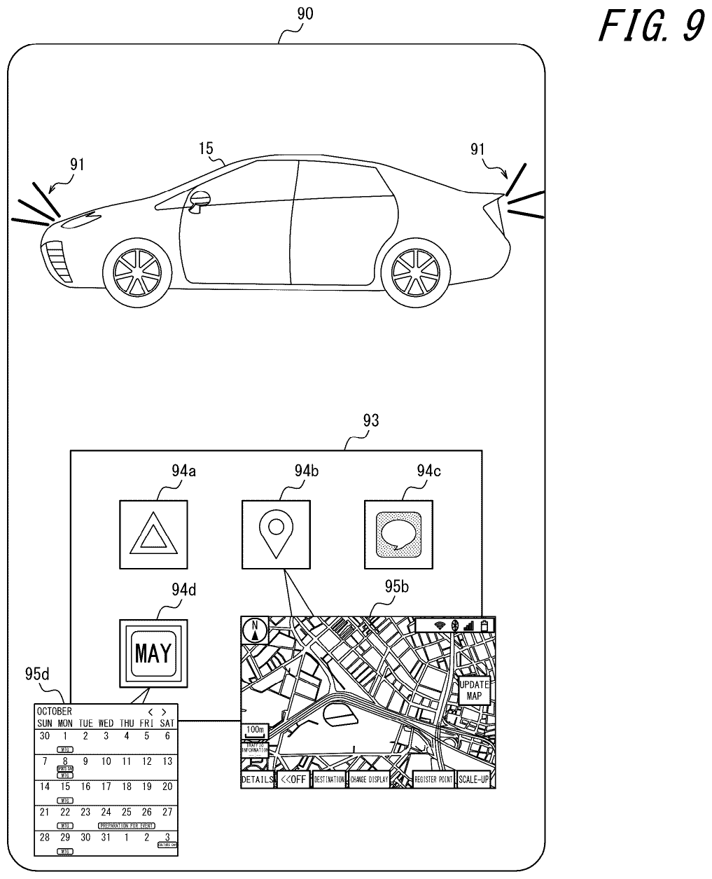

In step S805, the terminal apparatus 12 displays the interface image and accepts an operation from the user. The terminal apparatus 12 displays, to the user, the interface image to operate the equipment of the vehicle 15. For example, as an example of display in FIG. 9, the terminal apparatus 12 displays an interface image 93, along with a captured image 90 of the vehicle 15. For example, the terminal apparatus 12 may display the interface image 93 on a display of a smartphone, a tablet terminal, or the like, or may display the interface image 93 on a head-mounted display of a VR device. The terminal apparatus 12 accepts, for example, a tap operation, a gesture operation, or the like on operation objects 94a, 94b, 94c, and 94d included in the interface image 93.

In step S806, the terminal apparatus 12 transmits, to the server apparatus 10, operation information corresponding to the operation.

In response to the operation information, the server apparatus 10 transmits an imaging instruction to the terminal apparatus 13 in step S807, and transmits an operation instruction corresponding to the operation information to the in-vehicle apparatus 14 in step S808.

In step S809, the terminal apparatus 13 images the vehicle 15 in response to the imaging instruction. The terminal apparatus 13 controls, for example, the external camera 16 to image the vehicle 15, to acquire captured images.

In step S810, the in-vehicle apparatus 14 performs an operation according to the operation instruction. The operation includes activation of a navigation system, activation of an air conditioner, turning on a lighting system, sounding a sound system, or the like.

In step S811, the in-vehicle apparatus 14 transmits operation images to the server apparatus 10. The operation images are images generated by operating the in-vehicle apparatus 14, and include display images corresponding to various functions of the navigation system.

In step S812, the terminal apparatus 13 transmits the captured images to the server apparatus 10. The captured images are a moving image of any duration.

In step S813, the server apparatus 10 transmits the captured images and the operation images to the terminal apparatus 12. The server apparatus 10 may perform any image processing, such as brightness adjustment, color conversion, and various types of correction, on the captured images.

In step S815, the terminal apparatus 12 displays a confirmation image. The terminal apparatus 12 displays, to the user, a confirmation image to confirm the operation on the equipment of the vehicle 15. For example, as an example of display in FIG. 9, the terminal apparatus 12 displays the confirmation image superimposed on the captured image 90 of the vehicle 15 and the interface image 93. For example, a map image 95b is displayed as the confirmation image, in response to an operation on the operation object 94b to display a map of the navigation system. A calendar image 95d is also displayed as the confirmation image, in response to an operation on the operation object 94d to display a calendar. Furthermore, lighting of lights 91 of the vehicle 15 is indicated in the captured image 90, in response to an operation on the operation object 94a to turn on the lights of the vehicle 15. Here, the captured image 90 corresponds to the confirmation image. The confirmation image may be accompanied by audio information. For example, when an operation to sound the horn is performed in the interface image 93, the camera 16 collects sound along with the captured images when the horn of the vehicle 15 sounds. The sound added to the captured images of the vehicle 15 may then be played and output by the terminal apparatus 12. When a car audio of the navigation system is activated in the interface image 93, audio information may be transmitted from the in-vehicle apparatus 14 along with the operation images, and audio may be played and output by the terminal apparatus 12.

The user can thereby confirm and verify the current state, that is, the operation on the equipment of the vehicle 15, as a specific object that the user has purchased, while waiting for delivery of the vehicle 15. Therefore, it is possible to improve the convenience of users who are waiting for delivery of vehicles.

In a variation, in step S813, the server apparatus 10 may transmit guidance information to the terminal apparatus 12, in addition to the captured images and the operation images. The guidance information is information to explain each function and option in the equipment of the vehicle 15. The terminal apparatus 12 can display the guidance information in response to any operation, e.g., a long press on the operation objects 94a, 94b, 94c, and 94d in the interface image 93. For example, the guidance information is an explanation of the operation of the navigation system, the air conditioner, the lighting system, the sound system, or the like. Alternatively, the guidance information may be in the form of a quiz that allows the user to select, from a list of options, a correct answer for the operation of the navigation system, the air conditioner, the lighting system, the sound system, or the like. The user's interest can be enhanced by displaying or audibly outputting such guidance information.

In a further variation, the server apparatus 10 collects, from the in-vehicle apparatus 14, information on operation history of each function of the equipment. By collecting the operation history of each function not only from the particular vehicle 15 but also from in-vehicle apparatuses 14 of other vehicles, the server apparatus 10 assigns priority to each function based on the frequency with which the function is used. The server apparatus 10 then selects guidance information for, for example, a top arbitrary number of functions, according to the priority, and transmits the selected guidance information to the terminal apparatus 12. The user can thereby check the guidance information for more frequently used functions. This allows the user to gain prior knowledge of the functions that are likely to be used more frequently, before the vehicle 15 is delivered.

In the above embodiment, a processing/control program that specifies operations of the terminal apparatuses 12 and 13 and the in-vehicle apparatus 14 may be stored in the memory 22 of the server apparatus 10 or in a memory of another server apparatus, and be downloaded onto each apparatus via the network 11. The processing/control program may also be stored on a non-transitory recording/storage medium readable by each apparatus, and each apparatus may read the program from the medium.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each element, each step, or the like can be rearranged without logical inconsistency, and a plurality of elements, steps, or the like can be combined into one or divided.

Examples of some embodiments of the present disclosure are described below. However, it should be noted that the embodiments of the present disclosure are not limited to these examples.

[Appendix 1] An information processing apparatus comprising:
a communication interface;
a memory configured to store information indicating a delivery status of a certain vehicle; and
a controller configured to communicate by the communication interface,
wherein the controller is configured to transmit, to a terminal apparatus, information to confirm a current status of the certain vehicle on condition that the delivery status reaches a predetermined status.

[Appendix 2] The information processing apparatus according to appendix 1, wherein the information to confirm the current status is an image representing an exterior of the certain vehicle including an exterior part, or an image representing an interior of the certain vehicle including an interior part.

[Appendix 3] The information processing apparatus according to appendix 1 or 2, wherein the information to confirm the current status is an operation screen to accept an operation on equipment of the certain vehicle, or an image representing an operation of the equipment.

[Appendix 4] The information processing apparatus according to appendix 3, wherein the equipment includes a navigation system, an air conditioner, a lighting system, and/or a sound system.

[Appendix 5] The information processing apparatus according to appendix 3 or 4, wherein the controller is configured to incorporate, in the operation screen, guidance information guiding the operation on the equipment.

[Appendix 6] The information processing apparatus according to appendix 5, wherein the memory is configured to generate the guidance information, based on usage history information indicating a usage status of equipment in another vehicle associated with the certain vehicle.

[Appendix 7] The information processing apparatus according to any one of appendices 1 to 6, wherein
the terminal apparatus is a wearable terminal that can display an image to a user, and
the controller is configured to generate an image that can be displayed on the wearable terminal, the image corresponding to the information to confirm the current status.

[Appendix 8] A system comprising:
an information processing apparatus configured to store information indicating a delivery status of a certain vehicle; and
a terminal apparatus configured to communicate with the information processing apparatus,
wherein
the information processing apparatus is configured to transmit, to the terminal apparatus, information to confirm a current status of the certain vehicle on condition that the delivery status reaches a predetermined status, and
the terminal apparatus is configured to output the information to confirm the current status.

[Appendix 9] The system according to appendix 8, wherein the information to confirm the current status is an image representing an exterior of the certain vehicle including an exterior part, or an image representing an interior of the certain vehicle including an interior part.

[Appendix 10] The system according to appendix 8 or 9, wherein the information to confirm the current status is an operation screen to accept an operation on equipment of the certain vehicle, or an image representing an operation of the equipment.

[Appendix 11] The system according to appendix 10, wherein the equipment includes a navigation system, an air conditioner, a lighting system, and/or a sound system.

[Appendix 12] The system according to appendix 10 or 11, wherein the information processing apparatus is configured to incorporate, in the operation screen, guidance information guiding the operation on the equipment. [Appendix 13] The system according to appendix 12, wherein the information processing apparatus is configured to generate the guidance information, based on usage history information indicating a usage status of equipment in another vehicle associated with the certain vehicle.

[Appendix 14] The system according to any one of appendices 8 to 13, wherein
the terminal apparatus is a wearable terminal that can display an image to a user, and
the information processing apparatus is configured to generate an image that can be displayed on the wearable terminal, the image corresponding to the information to confirm the current status.

[Appendix 15] An operating method for a system including an information processing apparatus configured to store information indicating a delivery status of a certain vehicle, and a terminal apparatus configured to communicate with the information processing apparatus, the operating method comprising:
transmitting, by the information processing apparatus to the terminal apparatus, information to confirm a current status of the certain vehicle on condition that the delivery status reaches a predetermined status; and
outputting, by the terminal apparatus, the information to confirm the current status.

[Appendix 16] The operating method according to appendix 15, wherein the information to confirm the current status is an image representing an exterior of the certain vehicle including an exterior part, or an image representing an interior of the certain vehicle including an interior part.

[Appendix 17] The operating method according to appendix 15 or 16, wherein the information to confirm the current status is an operation screen to accept an operation on equipment of the certain vehicle, or an image representing an operation of the equipment.

[Appendix 18] The operating method according to appendix 17, wherein the equipment includes a navigation system, an air conditioner, a lighting system, and/or a sound system.

[Appendix 19] The operating method according to appendix 17 or 18, wherein the information processing apparatus is configured to incorporate, in the operation screen, guidance information guiding the operation on the equipment.

[Appendix 20] The operating method according to any one of appendices 17 to 19, wherein the information processing apparatus is configured to generate the guidance information, based on usage history information indicating a usage status of equipment in another vehicle associated with the certain vehicle.

1. An information processing apparatus comprising:
a communication interface;
a memory configured to store information indicating a delivery status of a certain vehicle; and
a controller configured to communicate by the communication interface,
wherein the controller is configured to transmit, to a terminal apparatus, information to confirm a current status of the certain vehicle on condition that the delivery status reaches a predetermined status.

2. The information processing apparatus according to claim 1, wherein the information to confirm the current status is an image representing an exterior of the certain vehicle including an exterior part, or an image representing an interior of the certain vehicle including an interior part.

3. The information processing apparatus according to claim 1, wherein the information to confirm the current status is an operation screen to accept an operation on equipment of the certain vehicle, or an image representing an operation of the equipment.

4. The information processing apparatus according to claim 3, wherein the equipment includes a navigation system, an air conditioner, a lighting system, and/or a sound system.

5. The information processing apparatus according to claim 3, wherein the controller is configured to incorporate, in the operation screen, guidance information guiding the operation on the equipment.

6. The information processing apparatus according to claim 5, wherein the memory is configured to generate the guidance information, based on usage history information indicating a usage status of equipment in another vehicle associated with the certain vehicle.

7. The information processing apparatus according to claim 1, wherein
the terminal apparatus is a wearable terminal that can display an image to a user, and
the controller is configured to generate an image that can be displayed on the wearable terminal, the image corresponding to the information to confirm the current status.

8. A system comprising:
an information processing apparatus configured to store information indicating a delivery status of a certain vehicle; and
a terminal apparatus configured to communicate with the information processing apparatus,
wherein
the information processing apparatus is configured to transmit, to the terminal apparatus, information to confirm a current status of the certain vehicle on condition that the delivery status reaches a predetermined status, and
the terminal apparatus is configured to output the information to confirm the current status.

9. The system according to claim 8, wherein the information to confirm the current status is an image representing an exterior of the certain vehicle including an exterior part, or an image representing an interior of the certain vehicle including an interior part.

10. The system according to claim 8, wherein the information to confirm the current status is an operation screen to accept an operation on equipment of the certain vehicle, or an image representing an operation of the equipment.

11. The system according to claim 10, wherein the equipment includes a navigation system, an air conditioner, a lighting system, and/or a sound system.

12. The system according to claim 10, wherein the information processing apparatus is configured to incorporate, in the operation screen, guidance information guiding the operation on the equipment.

13. The system according to claim 12, wherein the information processing apparatus is configured to generate the guidance information, based on usage history information indicating a usage status of equipment in another vehicle associated with the certain vehicle.

14. The system according to claim 8, wherein
the terminal apparatus is a wearable terminal that can display an image to a user, and
the information processing apparatus is configured to generate an image that can be displayed on the wearable terminal, the image corresponding to the information to confirm the current status.

15. An operating method for a system including an information processing apparatus configured to store information indicating a delivery status of a certain vehicle, and a terminal apparatus configured to communicate with the information processing apparatus, the operating method comprising:
transmitting, by the information processing apparatus to the terminal apparatus, information to confirm a current status of the certain vehicle on condition that the delivery status reaches a predetermined status; and
outputting, by the terminal apparatus, the information to confirm the current status.

16. The operating method according to claim 15, wherein the information to confirm the current status is an image representing an exterior of the certain vehicle including an exterior part, or an image representing an interior of the certain vehicle including an interior part.

17. The operating method according to claim 15, wherein the information to confirm the current status is an operation screen to accept an operation on equipment of the certain vehicle, or an image representing an operation of the equipment.

18. The operating method according to claim 17, wherein the equipment includes a navigation system, an air conditioner, a lighting system, and/or a sound system.

19. The operating method according to claim 17, wherein the information processing apparatus is configured to incorporate, in the operation screen, guidance information guiding the operation on the equipment.

20. The operating method according to claim 17, wherein the information processing apparatus is configured to generate the guidance information, based on usage history information indicating a usage status of equipment in another vehicle associated with the certain vehicle.
